(19) United States
(12) Patent Application Publication
(10) Pub. No.: US 2023/0201924 A1
(43) Pub. Date: Jun. 29, 2023

(54) METHOD FOR REPAIRING OR MODIFYING A MODULAR CONCRETE BLOCK MOLD

(71) Applicant: HS 3D Performance GmbH, Lengenfeld (DE)

(72) Inventor: Jonas JACOB, Lengenfeld (DE)

(73) Assignee: HS 3D Performance GmbH, Lengenfeld (DE)

(21) Appl. No.: 17/927,124

(22) PCT Filed: May 27, 2021
(86) PCT No.: PCT/EP2021/064146

§ 371 Date: Nov. 22, 2022

(30) Foreign Application Priority Data
Jun. 2, 2020 (DE) 10 2020 114 657.4

(51) Int. Cl. B22F 5/00; B33Y 80/00; B33Y 10/00; B22F 10/85; B28B 7/34

(52) U.S. Cl. CPC B22F 5/007; B33Y 80/00; B33Y 10/00; B22F 10/85; B28B 7/346; B22F 2998/10; B28B 7/241

(57) ABSTRACT

In a method for repairing or modifying a modular concrete block mold having multiple mold parts, a replacement mold part for a mold part to be replaced of the concrete block mold is additively manufactured and the replacement mold part is installed in the concrete block mold in place of the mold part to be replaced, or a region of a mold part to be adapted of the concrete block mold is additively manufactured and the mold part adapted in this way is then installed in the concrete block mold.

The invention relates to a method for repairing or modifying a modular concrete block mold having multiple mold parts.

Concrete block molds are used to produce molded blocks. A concrete mix is poured into the concrete block mold, and a block-making machine compacts the concrete mix in the concrete block mold to create a concrete block. The concrete block mold comprises a lower mold part having one or more mold cavities into which the concrete mix is poured, and an upper mold part having a punching unit for compacting the concrete mixture in the mold cavities. The punching unit comprises pressure plates that can engage in the mold cavities of the lower mold part. The lower mold part is open at the top and bottom, with the underside being closed by a horizontal base. The concrete mix is poured through the upper openings in the mold cavities and is then pressed by the pressure plates, which are lowered into the mold cavities through the upper openings by means of a loading unit. By shaking the base, the concrete mix solidifies to form dimensionally stable molded concrete parts. In a final step, the molded concrete parts are demolded through the lower openings in the zo mold cavities.

Concrete block molds in a modular design comprise multiple mold parts that are detachably interconnected to form the concrete block mold. The modular design allows individual mold parts to be replaced for repair purposes, so that the entire concrete block mold does not have to be replaced in the event of wear or defects and, in contrast with concrete block molds having permanently welded mold parts, a more economical and sustainable use of the concrete block mold is possible. The replacement mold parts, like the mold parts of the concrete block mold, are manufactured using conventional machining processes and/or casting processes.

The object is to specify a method by means of which such a modular concrete block mold can be repaired in a simple manner.

According to the method for repairing or modifying a modular concrete block mold having multiple mold parts, a replacement mold part for a mold part to be replaced of the concrete block mold is additively manufactured and the replacement mold part is installed in the concrete block mold in place of the mold part to be replaced, or a region of a mold part to be adapted of the concrete block mold is additively manufactured and the mold part adapted in this way is then reinstalled in the concrete block mold.

It should be noted that the method not only allows a defective or worn concrete block mold to be repaired, but also allows it to be adapted to changed production circumstances, for example a changed layout of the concrete blocks to be manufactured. Additive manufacturing not only makes it possible to replace a mold part as a whole, but alternatively also makes it possible to rebuild and/or change only a region of a mold part and then continue to use the adapted mold part, which is reinstalled in the concrete block mold.

Additive manufacturing, also known as rapid manufacturing, refers to automated processes that produce three-dimensional physical objects from a data set. To do this, volume elements are built up or joined together in layers, so that no mold-part-dependent tools are required. Additive manufacturing processes of this kind are also referred to as 3D printing. In view of the stresses to which the concrete block mold is subjected, the replacement mold part or the adapted mold part is advantageously made of metal using a 3D metal printing process. In 3D metal printing, an energy source such as a laser sinters or melts a metal powder to create the object to be manufactured, usually in layers. The powder can be present in a powder bed or be projected by means of a nozzle. The additive manufacturing of mold parts is hitherto unknown in mold construction for block-making machines.

The original modular concrete block mold produced in its entirety is also referred to as the basic mold or basic construction. It has usually been manufactured in a conventional manner by a casting process or a machining process, for example milling, so that the manufacture of the replacement mold part or the adapted mold part differs from the manufacture of the mold part to be replaced or adapted. Nevertheless, the basic mold or at least mold parts of it may also have been additively manufactured wholly or in part.

In a first variant, the replacement mold part replaces a mold part of the concrete block mold. In other words: A mold part of the concrete block mold is removed and the replacement mold part is installed instead. In a second variant, the adapted mold part is a mold part of the concrete block mold that has been changed by additive manufacturing. In other words: A mold part of the concrete block mold is removed, changed by additive manufacturing and reinstalled in the concrete block mold. Replacement and adaptation can be carried out multiple times for the same mold part or different mold parts during the life of the concrete block mold. Both variants are based on the same inventive concept, namely the use of additive manufacturing in mold construction for block-making machines.

Additive manufacturing allows quick, easy and decentralized repair of the concrete block mold when the mold part to be replaced or adapted is worn and/or defective according to the two variants. This is possible by replacing the worn and/or defective mold part or by rebuilding the worn and/or defective region in the mold part to be adapted by additive manufacturing. During repair, the shape of the replacement mold zo part or the adapted mold part usually matches the shape of the mold part to be replaced or adapted in the non-worn or non-defective state. During adaptation, the additive manufacturing can be preceded by pretreatment of the mold part, for example a surface treatment or removal of further regions. During adaptation, the additively manufactured region can be printed directly onto the mold part to be adapted or printed separately and then connected to the mold part to be adapted, for example by gluing, welding or suitable connecting means. Wear refers to material wear and tear through use of the concrete block mold. A defect is understood to mean damage in a broader sense than just wear, whereby the damage can result from external influences or production errors, for example.

Modification involves replacing the mold part, which need not be worn or defective, with a part of which the shape differs from the shape of the mold part to be replaced in the non-worn or non-defective state. This allows the concrete block mold to be changed, for example to change the layout of the concrete blocks that can be produced with it. The same objective can be achieved by shaping the additively manufactured region of the adapted mold part such that the shape of the adapted mold part differs from the shape of the mold part to be adapted in the non-worn or non-defective state. The additively manufactured region of the adapted mold part can be a region that goes beyond the shape of the mold part to be adapted in the non-worn or non-defective state, so that additional regions are applied to the mold part by the additive manufacturing.

Often the mold part to be replaced or adapted is a mold part of a mold cavity or a pressure plate of the concrete block mold, since such mold parts are prone to wear and affect the layout of the concrete block. The concrete block mold and its mold parts are designed for many wear part changes, so that the same mold part can be replaced multiple times. It is possible to gradually replace conventionally manufactured mold parts with additively manufactured replacement mold parts.

The great advantage of additive manufacturing in the described method is that the manufacture of the replacement mold parts or the adapted mold parts is no longer limited to the production site of the basic mold, i.e. the manufacturer's plant, but is possible on a decentralized and worldwide basis, provided that a suitable manufacturing device, i.e. a 3D metal printer, is available with which the replacement mold part or the adapted mold part can be manufactured. The modular design of the concrete block mold makes it easier to replace all wear parts. The mold data required for manufacture can be transmitted from the manufacturer of the basic mold to the production site of the replacement mold part or the adapted mold part in an easier and faster manner than a physical replacement mold part. This reduces the time required for repairing or modifying the concrete block mold to the printing time and the time required for installation. There is no effort involved in shipping, as the manufacturing data can be provided electronically almost immediately. This method is ecologically advantageous and cost-efficient due to the reduction in transport costs.

The mold data can be provided, for example, by means of a database that provides mold data relevant to the additive manufacturing for the replacement mold part or the adapted mold part. It is not only the mold data of the corresponding mold part that can be provided, but also layout variants, meaning a data set for the replacement mold part or the adapted mold part can be selected from a plurality of mold data, so that the shape of the replacement mold part or the adapted mold part differs from the shape of the mold part to be replaced or adapted, or not as the case may be. In this way, the user of the concrete block mold can additively manufacture the replacement mold part themselves as soon as the mold data have been provided to them by the manufacturer.

Of course, it is still possible for the replacement mold part or the adapted mold part to be manufactured by the manufacturer of the basic mold and then sent to the user of the concrete block mold. In this case, the modular concrete block mold has been manufactured as a basic mold at the manufacturer's production site, and the replacement mold part or the adapted mold part is additively manufactured at the same production site or is additively manufactured at another production site of the manufacturer after mold data relevant to the additive manufacturing have been transmitted. For the manufacturer, this results in the advantage of fast, flexible and needs-based manufacturing of the replacement mold part or the adapted mold part, which does not necessarily have to be carried out at the production site of the basic mold, but can also take place in branches anywhere in the world that have a 3D metal printer and may be close to the user. The manufacture of replacement mold parts in particular represents a manufacturing option in the branches, since it only involves the 3D printing process. This makes it possible to reduce effort and save time because the shipping route is shortened, which is ecologically advantageous and cost-efficient.

The method is suitable not only for repairing defective or worn mold parts, but also for modifying them so that, for example, the layout of the concrete blocks can be changed or the concrete block mold can be adapted to a changed production environment, for example by modifying the frame. For the user, in particular when it comes to modification, the advantages of the manufacturing options described are that long process chains are avoided, so that orders for concrete blocks can be responded to more quickly, which lends itself to shorter delivery times. It is no longer necessary to construct a completely new concrete block mold and have it manufactured by the manufacturer, but only to replace or adapt individual mold parts, which can be carried out by the user, especially in the first case.

The manufacturer also benefits from the method because it can make savings in terms of the variety of machines and the vertical range of manufacture, for example cutting and CNC machining, at the other production sites that are not intended for the manufacture of the basic mold. Only a suitable device for additive manufacturing, i.e. a 3D metal printer, is required at the other production sites for replacement mold parts or adapted mold parts.

Additive manufacturing allows replacement parts to be produced “just in time,” thus avoiding long delivery times or costly warehousing. In addition, the method allows replacement parts to be available quickly, and the availability of the molding tools is increased.

Additive manufacturing also offers possible weight savings on the mold parts on account of improved mold part topology. 3D printing allows the production of mold parts with shapes that cannot be produced with conventional manufacturing processes, such as undercuts and cavities. The manufacturer can already make use of this advantage during the manufacture of the basic mold by manufacturing it additively at least in part. Alternatively or additionally, the shape of the replacement mold part or zo the adapted mold part can differ from the shape of the mold part to be replaced or adapted by having topological advantages. The weight savings associated with the topology make transport easier.

Some embodiments are explained in more detail below with reference to the drawings.

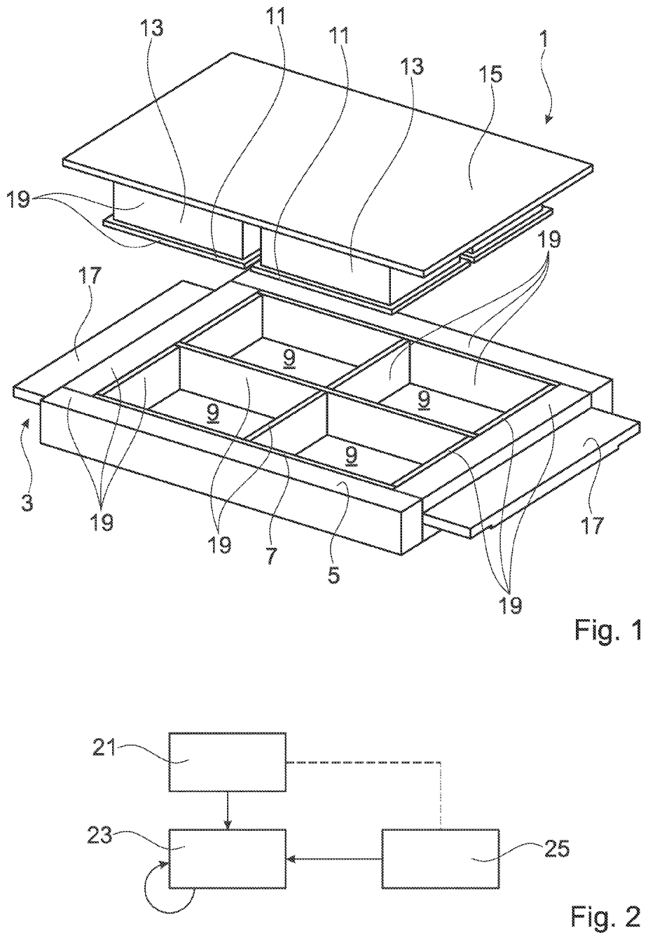

FIG. 1 shows an embodiment of a modular concrete block mold.

FIG. 2 illustrates the steps of production and possible repair and/or modification of a modular concrete block mold.

In the figures, the same or functionally equivalent components are provided with the same reference signs.

FIG. 1 shows an embodiment of a modular concrete block mold having an upper mold part 1 and a lower mold part 3. The lower mold part 3 has a frame 5 which surrounds an insert 7. The insert 7 has multiple recesses 9 which are designed as mold cavities. Flanges 17 on the sides of the frame 5 enable it to be mounted in a block-making machine (not shown). The upper mold part 1 is arranged opposite the recesses 9 and has a plurality of pressure plates 11 which correspond approximately to the recesses 9 in terms of their dimensions. The pressure plates 11 are connected via pressure punches 13 to a punching plate 15 which combines the pressure plates 11 and the pressure punches 13 into one unit. Both the upper mold part 1 and the lower mold part 3 are assembled from detachably connected mold parts 19. The frame 5 and the insert 7 are composed of multiple mold parts 19. The connection between the mold parts 19 can be established, for example, by tongue-and-groove connections and/or plug-in connections and/or screws. The assembled mold parts 19 form the modular concrete block mold, in which the mold parts 19 are interchangeable, so that in the case of a defect or wear, only the corresponding mold part needs to be replaced or adapted. The replacement and/or adaptation of one or more mold parts 19 also allows the concrete block mold to be modified.

FIG. 2 illustrates the steps of production and possible repair and/or modification of a modular concrete block mold.

The modular concrete block mold manufactured by the manufacturer as a whole is referred to as the basic mold. It is designed depending on the layout of the concrete blocks to be manufactured with it and is usually manufactured using a conventional manufacturing process, for example a machining process or a casting process, as illustrated in step 21. Nevertheless, the basic mold or at least mold parts of it may also have been additively manufactured wholly or in part. The manufacture of the basic mold includes the manufacture of the mold parts 19 of the concrete block mold and the assembly thereof such that the mold parts 19 are detachably connected. The assembly takes place at a central production site of the manufacturer, where the mold parts have usually also been manufactured, and it is then delivered to the user of the concrete block mold.

Step 23 illustrates repair or modification of the modular concrete block mold having multiple mold parts. In the case of repair or modification, a replacement mold part for a mold part to be replaced of the concrete block mold is additively manufactured and the replacement mold part is installed in the concrete block mold in place of the mold part to be replaced, or a region of a mold part to be adapted of the concrete block mold is additively manufactured and the mold part adapted in this way is then installed in the concrete block mold. In the case of a defect, wear or desired modification of the concrete block mold, it is possible to replace or adapt mold parts using an additive manufacturing process, advantageously 3D metal printing. Mold parts to be replaced are removed from the concrete block mold and replaced with a new, additively manufactured replacement mold part that is installed in the concrete block mold. A mold part to be adapted is removed from the concrete block mold, a region of the mold part is additively manufactured and the mold part that has thus been adapted is reinstalled in the concrete block mold. Replacement and adaptation can be carried out multiple times for the same mold part or different mold parts during the life of the concrete block mold, as illustrated by the returning arrow.

Additive manufacturing requires mold data, i.e. design data, for the replacement mold part or the adapted mold part, which can be provided for example by the manufacturer, as illustrated in step 25. These mold data can be present as 3D CAD data, by means of which the 3D metal printer is controlled. Such mold data can be provided in a very short time, meaning the time required to provide the replacement mold part or the adapted mold part amounts only to its printing time.

It should be noted that the method not only allows a defective or worn concrete block mold to be repaired, but also allows it to be adapted to changed production requirements, for example a changed layout of the concrete blocks to be manufactured. The corresponding steps 23 and 25 can be carried out multiple times during the life of the concrete block mold, and so repair and modification increase the life of the concrete mold.

The replacement mold part or the adapted mold part can be manufactured at the manufacturer's central production site at which the basic mold was also manufactured, or at one of its branches, or by the user of the concrete block mold. The latter case includes not only 3D printing by the user themselves, but also by a third party commissioned by them. With these options, additive manufacturing allows for increased availability of mold parts because there are different production sites available for step 23, whether on the manufacturer or on the user side: The user can print out the replacement mold part themselves using the mold data provided by the manufacturer. This can be done on an as-needed or in-stock basis. The manufacturer can print the replacement mold part themselves at the production site of the basic mold and then send it to the user for installation. If the user has sent the concrete block mold to the manufacturer, the replacement mold part or the adapted mold part is installed by the manufacturer and the concrete block mold is then sent back to the user. If a defect occurs immediately after production, the manufacturer can still use additive manufacturing to repair and/or even modify the mold before delivery. There is also the possibility that the mold part to be replaced is printed at another production side of the manufacturer after the mold data have been made available there. In this case, too, the installation can be carried out by the user or at the other production site.

The options described above are also applicable for the mold part to be adapted. The adaptation can be made by the user at the central production site or at another production site. Since 3D printing a replacement mold part as a whole is less complex than adapting a mold part, the adaptation is more likely to be done by the manufacturer, whether at the basic mold production site or at another production site.

The decentralized manufacturing by means of additive manufacturing can be assisted by a database of which the data pool contains mold data. Such a database can be provided by the manufacturer and facilitate the transfer of mold data for the decentralized manufacturing. As an alternative or in addition to such a database, a data transfer system can be provided by which mold data of the mold part to be replaced or adapted is made available as with the original mold part or with incorporated changes, for example according to user wishes or specifications.

The features indicated above and in the claims, as well as the features which can be seen in the figures, can advantageously be implemented both individually as well as in various combinations. The invention is not limited to the embodiments described, but may be modified in many ways within the capabilities of a person skilled in the art.

### REFERENCE SIGNS

1 upper mold part

3 lower mold part

5 frame

7 insert

9 recess

11 pressure plate

13 pressure punch

15 punching plate

17 flange

19 mold part

21 step

23 step

25 step

1. A method for repairing or modifying a modular concrete block mold having multiple mold parts (19),
in which a replacement mold part for a mold part (19) to be replaced of the concrete block mold is additively manufactured and the replacement mold part is installed in the concrete block mold in place of the mold part (19) to be replaced,
or in which a region of a mold part (19) to be adapted of the concrete block mold is additively manufactured and the mold part (19) adapted in this way is then installed in the concrete block mold.

2. The method according to claim 1, wherein the additive manufacturing comprises a 3D metal printing process.

3. The method according to claim 1, wherein the concrete block mold has been manufactured at least in part by a casting process and/or a machining process

4. The method according to claim 1,
wherein the mold part (19) to be replaced or adapted is worn and/or defective.

5. The method according to claim 4,
wherein the shape of the replacement mold part matches the shape of the mold part (19) to be replaced in the non-worn or non-defective state.

6. The method according to claim 4,
wherein the shape of the replacement mold part differs from the shape of the mold part (19) to be replaced in the non-worn or non-defective state.

7. The method according to claim 1,
wherein the mold part (19) to be adapted has worn and/or defective regions which are built up or repaired by additive manufacturing.

8. The method according to claim 7,
wherein the additively manufactured region of the adapted mold part is shaped such that the shape of the adapted mold part matches the shape of the mold part to be adapted in the non-worn or non-defective state.

9. The method according to claim 7,
wherein the additively manufactured region of the adapted mold part is shaped such that the shape of the adapted mold part differs from the shape of the mold part to be adapted in the non-worn or non-defective state.

10. The method according to claim 7,
wherein the additively manufactured region of the adapted mold part is a region that goes beyond the shape of the mold part to be adapted in the non-worn or non-defective state.

11. The method according to claim 1,
wherein the mold part (19) to be replaced or adapted is a mold part of a mold cavity (5) or a pressure plate (11) or a stamp (15) of the concrete block mold.

12. The method according to claim 1,
wherein the modular concrete block mold has been manufactured at a production site and the replacement mold part or the adapted mold part is additively manufactured at the same production site or is additively manufactured at another production site after mold data relevant to the additive manufacturing have been transmitted.

13. The method according to claim 1,
wherein the mold data relevant to the additive manufacturing for the mold part (19) to be replaced or adapted can be selected from a plurality of mold data in a database.
